(19) United States
(12) Patent Application Publication
(10) Pub. No.: US 2026/0235241 A1
(43) Pub. Date: Aug. 13, 2026

(54) PIPE JOINT

(71) Applicant: PILLAR CORPORATION, Osaka (JP)

(72) Inventors: Shohei Minamihara, Osaka (JP); Hiroki Tanabe, Osaka (JP)

(73) Assignee: PILLAR CORPORATION, Osaka (JP)

(21) Appl. No.: 19/154,784

(22) PCT Filed: Nov. 6, 2023
(86) PCT No.: PCT/JP2023/039948

§ 371 Date: Aug. 7, 2025

(30) Foreign Application Priority Data
Mar. 28, 2023 (JP) 2023-051322

(51) Int. Cl. F16L 37/20

(52) U.S. Cl. CPC F16L 37/20

(57) ABSTRACT

A pipe joint includes: a tubular first joint configured to be connected to one pipe and having an insertion portion extending in an axial direction; and a tubular second joint configured to be connected to another pipe and having an insertion target portion into which the insertion portion is inserted in the axial direction. A sealing surface pressure is generated at the insertion portion when the insertion portion is inserted into the insertion target portion. The pipe joint includes an assembly mechanism for inserting the insertion portion into the insertion target portion by utilizing a lever principle.

### TECHNICAL FIELD

The present invention relates to a pipe joint.

### BACKGROUND ART

For example, a pipe joint described in PATENT LITERATURE 1 is known as a pipe joint for coupling various pipes such as a rubber hose and a metal pipe placed within an automobile. The pipe joint of PATENT LITERATURE 1 includes a main body to which one pipe is connected, and a sleeve to which another pipe is connected. An internal thread and an annular groove are formed in the main body. An external thread and an annular protrusion are formed in the sleeve. When the external thread of the sleeve is screwed into the internal thread of the main body, the annular protrusion of the sleeve is press-fitted into the annular groove of the main body. Accordingly, the main body and the sleeve are connected, and the connection portion therebetween is sealed.

### CITATION LIST

### Patent Literature

PATENT LITERATURE 1: Japanese Laid-Open Patent Publication No. 2022-131116

### SUMMARY OF THE INVENTION

### Technical Problem

In the pipe joint, in order to improve sealing performance, it is necessary to increase the sealing surface pressure of the annular protrusion against the annular groove. However, increasing the sealing surface pressure results in an increase in press-fitting load when press-fitting the annular protrusion into the annular groove, so that work of assembling the pipe joint becomes heavy labor.

The present disclosure has been made in view of such circumstances, and an object of the present disclosure is to allow work of assembling a pipe joint to be easily performed even if sealing performance is improved.

### Solution to Problem

(1) The present disclosure is directed to a pipe joint including: a tubular first joint configured to be connected to one pipe and having an insertion portion extending in an axial direction; and a tubular second joint configured to be connected to another pipe and having an insertion target portion into which the insertion portion is inserted in the axial direction, a sealing surface pressure being generated at the insertion portion when the insertion portion is inserted into the insertion target portion, wherein the pipe joint includes an assembly mechanism for inserting the insertion portion into the insertion target portion by utilizing a lever principle.

In the pipe joint of the present disclosure, an operator can easily insert the insertion portion of the first joint into the insertion target portion of the second joint by using the assembly mechanism which utilizes the lever principle. Accordingly, even if the sealing surface pressure generated at the insertion portion is increased to improve sealing performance, work of assembling the pipe joint can be easily performed.
(2) In the pipe joint of (1) above, preferably, the assembly mechanism includes a rotation portion that is provided at an outer circumference of one joint out of the first joint and the second joint so as to be rotatable around a center line extending in a radial direction of the one joint, an engagement portion that is provided at the rotation portion and engageable with the other joint out of the first joint and the second joint by rotation of the rotation portion, and an operation portion that is provided at the rotation portion and on which a rotational operation for rotating the rotation portion about the center line as a fulcrum is performed, and the operation portion has a point of effort at which a force in a direction in which the insertion portion is inserted into the insertion target portion is applied to a point of action, which is an engagement portion between the engagement portion and the other joint, by the rotational operation.

In this case, the operator can perform a rotational operation for rotating the rotation portion around the fulcrum (center line) relative to the one joint by using the operation portion. At this time, by the engagement portion engaging with the other joint, a force in the direction in which the insertion portion of the first joint is inserted into the insertion target portion of the second joint is applied from the point of effort of the operation portion to the point of action which is the engagement portion between the engagement portion and the other joint. Accordingly, the operator can easily insert the insertion portion of the first joint into the insertion target portion of the second joint by utilizing the lever principle. Therefore, even if the sealing surface pressure generated at the insertion portion is increased to improve sealing performance, the work of assembling the pipe joint can be easily performed.
(3) In the pipe joint of (2) above, preferably, the engagement portion and the operation portion are provided integrally with the rotation portion.

In this case, the configuration of the pipe joint can be simplified.
(4) In the pipe joint of (2) or (3) above, preferably, the operation portion is movable from a pre-operation position located on the one joint side to a post-operation position located on the other joint side, by the rotational operation, and the pipe joint further includes a holding portion provided in the one joint and configured to hold the operation portion at the pre-operation position.

In this case, before the operator performs the rotational operation on the operation portion, the operation portion is held at the pre-operation position on the one joint side by the holding portion. In this state, when the operator brings the other joint closer to the one joint, the other joint can be inhibited from interfering with the operation portion. Accordingly, the work of assembling the pipe joint can be performed more easily.
(5) In the pipe joint of any one of (2) to (4) above, preferably, the operation portion is movable from a pre-operation position located on the one joint side to a post-operation position located on the other joint side, by the rotational operation, and the pipe joint further includes a blocking portion provided in the other joint and configured to block the operation portion from moving beyond the post-operation position during the rotational operation.

In this case, when the operator performs the rotational operation on the operation portion, the operation portion can be blocked from moving beyond the post-operation position, by the blocking portion. Accordingly, damage to the operation portion, the engagement portion, etc., due to an erroneous operation on the operation portion can be suppressed.
(6) In the pipe joint of any one of (2) to (5) above, preferably, the operation portion is movable from a pre-operation position located on the one joint side to a post-operation position located on the other joint side, by the rotational operation, and the pipe joint further includes a restricting portion provided in the other joint and configured to restrict the operation portion from moving from the post-operation position toward the pre-operation position side.

In this case, after the operator performs the rotational operation on the operation portion, the operation portion can be restricted from moving from the post-operation position toward the pre-operation position side, by the restricting portion. Accordingly, since the engagement portion is held in a state of being engaged with the other joint, movement of the insertion portion of the first joint in a direction of coming out from the insertion target portion of the second joint, due to vibration or the like, can be suppressed. As a result, a decrease in sealing performance due to a decrease in the sealing surface pressure of the insertion portion can be suppressed.
(7) In the pipe joint of any one of (2) to (6) above, preferably, the point of action is rotationally movable in a predetermined angular range centered on the fulcrum, by the rotational operation, and the angular range is set to a range bisected by a virtual line that is perpendicular to an axis of the one joint and the center line and passes through the fulcrum.

During the rotational operation on the operation portion, as the amount of movement of the point of action in a direction along the virtual line increases, a force in the direction along the axis, that is, in the direction in which the insertion portion is inserted into the insertion target portion, is dispersed and weakened. On the other hand, in (7) above, the amount of movement of the point of action in the direction along the virtual line can be reduced as much as possible, and thus, weakening of the force in the direction in which the insertion portion is inserted into the insertion target portion can be suppressed. In addition, in (7) above, since the angular range in which the point of action rotationally moves can be reduced as much as possible, an operating angle during the rotational operation on the operation portion can also be reduced. Accordingly, the work of assembling the pipe joint can be performed efficiently.
(8) In the pipe joint of any one of (2) to (7) above, preferably, the rotation portion is provided in the second joint.

In general, the second joint having the insertion target portion is longer in the axial direction than the first joint having the insertion portion. In (8) above, since the rotation portion is provided in the second joint which is relatively long in the axial direction, increasing the length of the second joint in the axial direction in order to ensure the space for providing the rotation portion can be suppressed as much as possible. Accordingly, an increase in the overall length of the pipe joint in the axial direction after assembly can be suppressed.

### Advantageous Effects of the Invention

According to the present disclosure, the work of assembling the pipe joint can be easily performed even if sealing performance is improved.

### BRIEF DESCRIPTION OF DRAWINGS

FIG. 1 is a perspective view of a pipe joint according to a first embodiment.

FIG. 2 is an axial cross-sectional view of the pipe joint in FIG. 1.

FIG. 3 is a perspective view of a first joint in FIG. 1 as seen from another side in an axial direction and the upper side.

FIG. 4 is a perspective view of a second joint in FIG. 1 as seen from one side in the axial direction and the lower side.

FIG. 5 is a side view of the pipe joint in FIG. 1.

FIG. 6 is a plan view of the pipe joint in FIG. 1.

FIG. 7 is a perspective view of an assembly mechanism.

FIG. 8 is a side view showing a state before the pipe joint is assembled.

FIG. 9 is a side view showing a state in the middle of assembling the pipe joint.

FIG. 10 is a side view showing a state in the middle of assembling the pipe joint.

FIG. 11 is an enlarged side view showing an angular range in which a point of action moves during rotational operation on an operation portion.

FIG. 12 is a schematic diagram showing two angular ranges different from each other.

FIG. 13 is an axial cross-sectional view of a pipe joint according to a second embodiment.

FIG. 14 is a perspective view of a pipe joint according to a third embodiment.

FIG. 15 is a side view of the pipe joint in FIG. 14.

FIG. 16 is a plan view of the pipe joint in FIG. 14.

FIG. 17 is a perspective view of an assembly mechanism in the pipe joint in FIG. 14.

FIG. 18 is a side view showing a state before the pipe joint in FIG. 14 is assembled.

### DETAILED DESCRIPTION

Next, preferred embodiments will be described with reference to the accompanying drawings. At least parts of the embodiments described below may be combined as desired.

### First Embodiment

### <Entire Configuration>

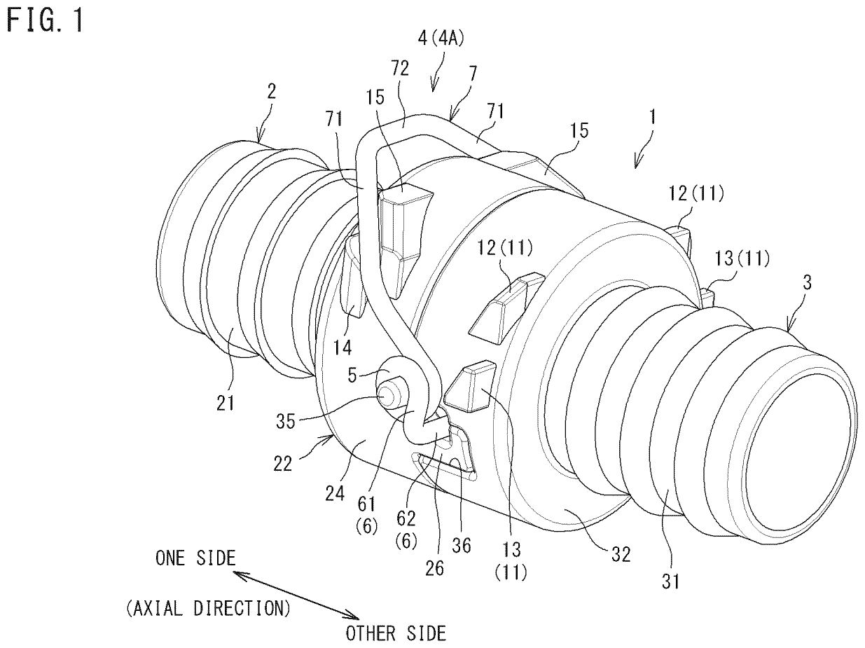

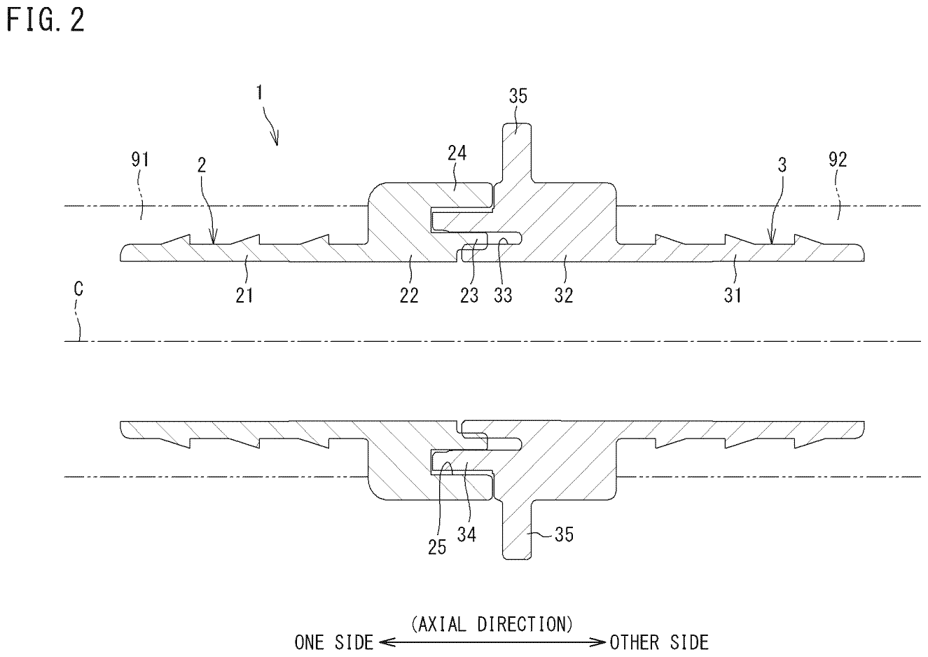

FIG. 1 is a perspective view of a pipe joint 1 according to a first embodiment. FIG. 2 is an axial cross-sectional view of the pipe joint 1 in FIG. 1. In FIG. 1 and FIG. 2, the pipe joint 1 is provided, for example, in a cooling line for a battery pack of an electric vehicle (EV) and is used to couple a first hose (one pipe) 91 and a second hose (another pipe) 92 through which cooling water (LLC) flows. The first hose 91 and the second hose 92 are made of a resin such as high-density polyethylene (HDPE).

The pipe joint 1 includes a first joint 2 and a second joint 3. The first joint 2 and the second joint 3 are both formed in a cylindrical shape from a resin material such as polyamide (PA) or glass fiber reinforced polyamide (PA-GF). The first joint 2 and the second joint 3 have the same inner diameter and are connected to each other in a state where the first joint 2 and the second joint 3 are arranged on the same axis C.

The first joint 2 is connected to the first hose 91, and the second joint 3 is connected to the second hose 92. The respective internal spaces of the first joint 2 and the second joint 3 communicate with the internal space of the first hose 91 and the internal space of the second hose 92, respectively. That is, the respective internal spaces of the first joint 2 and the second joint 3 function as a flow passage, for the LLC, connecting the two hoses 91 and 92.

Hereinafter, in this specification, the “axial direction” is a direction along the axis C. For convenience, the left side of FIG. 2 is referred to as “one side in the axial direction”, and the right side of FIG. 2 is referred to as “other side in the axial direction”. In addition, in this specification, the “radial direction” is a direction orthogonal to the axis C, and the “circumferential direction” is a direction around the axis C.

### <First Joint>

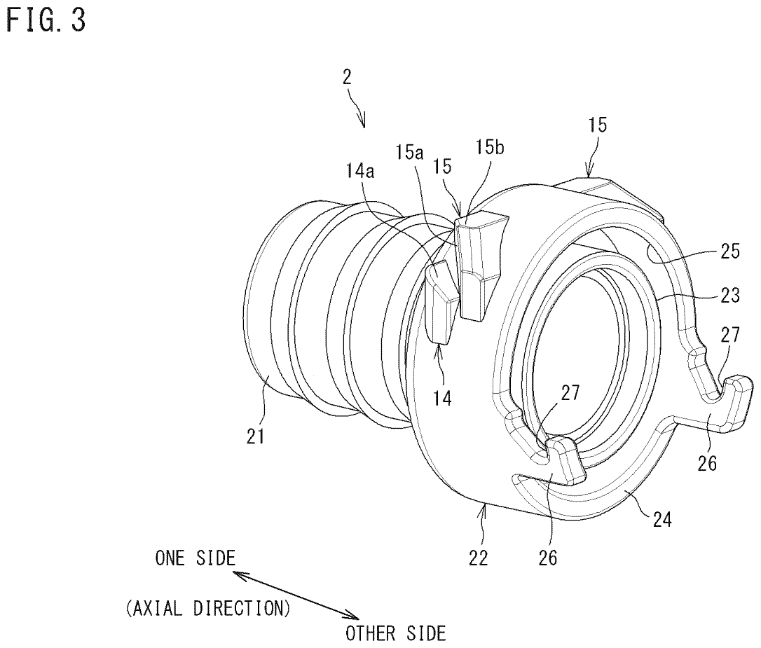

FIG. 3 is a perspective view of the first joint 2 in FIG. 1 as seen from the other side in the axial direction and the upper side. In FIG. 2 and FIG. 3, the first joint 2 includes a first connection portion 21 formed on the one side in the axial direction and a first main body portion 22 formed on the other side in the axial direction. The first connection portion 21 is a connection portion with the first hose 91. The outer diameter of the first connection portion 21 is slightly larger than the inner diameter of the first hose 91. The first connection portion 21 is press-fitted into the first hose 91 to expand an opening end portion of the first hose 91. The inner circumferential surface of the opening end portion of the first hose 91 squeezes the outer circumferential surface of the first connection portion 21 inward in the radial direction by a restoring force thereof. Accordingly, the first connection portion 21 is connected to the first hose 91, and the gap between the outer circumferential surface of the first connection portion 21 and the inner circumferential surface of the first hose 91 is sealed.

The first main body portion 22 is a connection portion with the second joint 3. The inner diameter of the first main body portion 22 is the same as the inner diameter of the first connection portion 21. The outer diameter of the first main body portion 22 is larger than the outer diameter of the first connection portion 21. Therefore, the thickness in the radial direction of the first main body portion 22 is larger than the thickness in the radial direction of the first connection portion 21.

The first main body portion 22 has a sealing protrusion (insertion portion) 23 extending toward the other side in the axial direction on the inner side in the radial direction, and an outer tube portion 24 extending toward the other side in the axial direction on the outer side in the radial direction. The sealing protrusion 23 is formed in a cylindrical shape. The outer tube portion 24 is formed in a cylindrical shape so as to be spaced outward in the radial direction from the sealing protrusion 23. An annular recessed groove 25 is formed between the sealing protrusion 23 and the outer tube portion 24 so as to be open on the other side in the axial direction.

The first main body portion 22 further has a pair of protrusion portions 26 provided on the outer tube portion 24. The pair of protrusion portions 26 are provided on the outer tube portion 24 so as to be spaced apart from each other in the circumferential direction and protrude toward the other side in the axial direction. Each protrusion portion 26 of the present embodiment is provided integrally with the first main body portion 22. An engagement groove 27 is formed on the upper side of each protrusion portion 26 in FIG. 3. The engagement groove 27 will be described in detail later.

### <Second Joint>

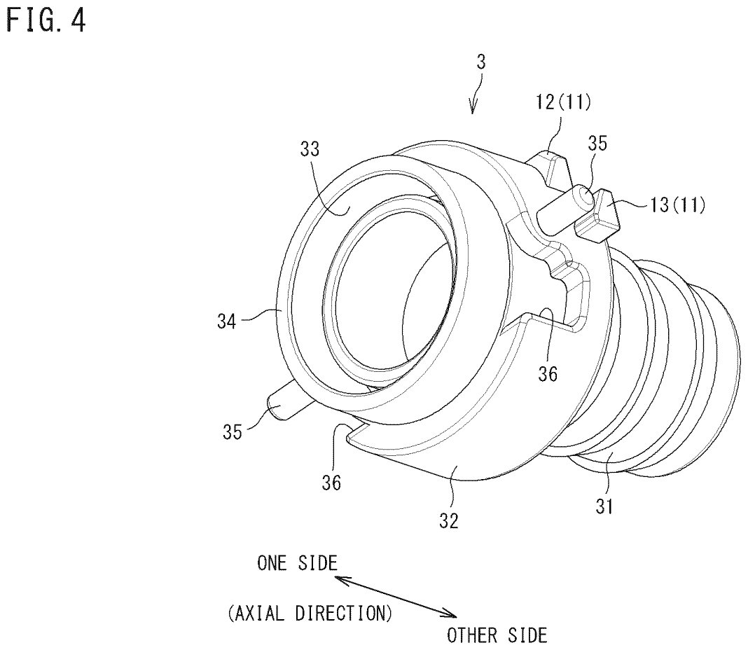

FIG. 4 is a perspective view of the second joint 3 in FIG. 1 as seen from the one side in the axial direction and the lower side. In FIG. 2 and FIG. 4, the second joint 3 includes a second connection portion 31 formed on the other side in the axial direction and a second main body portion 32 formed on the one side in the axial direction. The second connection portion 31 is a connection portion with the second hose 92. The outer diameter of the second connection portion 31 is slightly larger than the inner diameter of the second hose 92. The second connection portion 31 is press-fitted into the second hose 92 to expand an opening end portion of the second hose 92. The inner circumferential surface of the opening end portion of the second hose 92 squeezes the outer circumferential surface of the second connection portion 31 inward in the radial direction by a restoring force thereof. Accordingly, the second connection portion 31 is connected to the second hose 92, and the gap between the outer circumferential surface of the second connection portion 31 and the inner circumferential surface of the second hose 92 is sealed.

The second main body portion 32 is a connection portion with the first joint 2. The inner diameter of the second main body portion 32 is the same as the inner diameter of the second connection portion 31. The outer diameter of the second main body portion 32 is larger than the outer diameter of the second connection portion 31 and is the same as the outer diameter of the first main body portion 22. Therefore, the thickness in the radial direction of the second main body portion 32 is larger than the thickness in the radial direction of the second connection portion 31 and is the same as the thickness in the radial direction of the first main body portion 22.

The second main body portion 32 has a sealing groove (insertion target portion) 33 that is open on the one side in the axial direction on the inner side in the radial direction, and a projection portion 34 that protrudes toward the one side in the axial direction on the outer side in the radial direction. The sealing groove 33 is formed in a cylindrical shape such that the sealing protrusion 23 of the first joint 2 is press-fitted (inserted) thereinto from the one side in the axial direction. The outer diameter of the sealing groove 33 is the same as the outer diameter of the sealing protrusion 23. The inner diameter of the sealing groove 33 is slightly larger than the inner diameter of the sealing protrusion 23. The projection portion 34 is formed in a cylindrical shape such that the projection portion 34 is inserted into the recessed groove 25 of the first joint 2. The inner diameter of the projection portion 34 is the same as the inner diameter of the recessed groove 25. The outer diameter of the projection portion 34 is smaller than the outer diameter of the recessed groove 25.

The second main body portion 32 further has a pair of support portions 35 and a pair of cutout grooves 36. The pair of support portions 35 are each formed in a circular column shape and are provided so as to protrude outward in the radial direction at positions located at equal intervals (with a 180° phase difference) in the circumferential direction on the outer circumferential surface of the second main body portion 32. Each support portion 35 of the present embodiment is provided integrally with the second main body portion 32.

The pair of cutout grooves 36 are formed on the outer circumferential surface of the second main body portion 32 so as to be adjacent to the support portions 35 in the circumferential direction, respectively. Each cutout groove 36 is formed such that the protrusion portion 26 of the first joint 2 is inserted thereinto from the one side in the axial direction. Each cutout groove 36 of the present embodiment is formed in a substantially concave shape and is open on the one side in the axial direction and the outer side in the radial direction of the second main body portion 32.

Due to the above configuration, the projection portion 34 of the second joint 3 is inserted into the recessed groove 25 of the first joint 2 from the other side in the axial direction, and each protrusion portion 26 of the first joint 2 is inserted into each cutout groove 36 of the second joint 3 from the one side in the axial direction. In addition, the sealing protrusion 23 of the first joint 2 is press-fitted into the sealing groove 33 of the second joint 3 from the one side in the axial direction. When the sealing protrusion 23 is press-fitted into the sealing groove 33, the inner circumferential surface of the sealing protrusion 23 and the inner circumferential surface of the sealing groove 33 are brought into close contact with each other, and a sealing surface pressure is generated between these inner circumferential surfaces. Accordingly, the connection portion between the first joint 2 and the second joint 3 is sealed.

### <Assembly Mechanism>

In FIG. 1, the pipe joint 1 further includes an assembly mechanism 4 used during assembly thereof. In FIG. 2, the assembly mechanism 4 is not shown. The assembly mechanism 4 is used to insert the sealing protrusion 23 of the first joint 2 into the sealing groove 33 of the second joint 3 by utilizing a lever principle. The assembly mechanism 4 of the present embodiment is composed of, for example, a single rod-shaped member 4A made of the same resin material as the first joint 2 and the second joint 3.

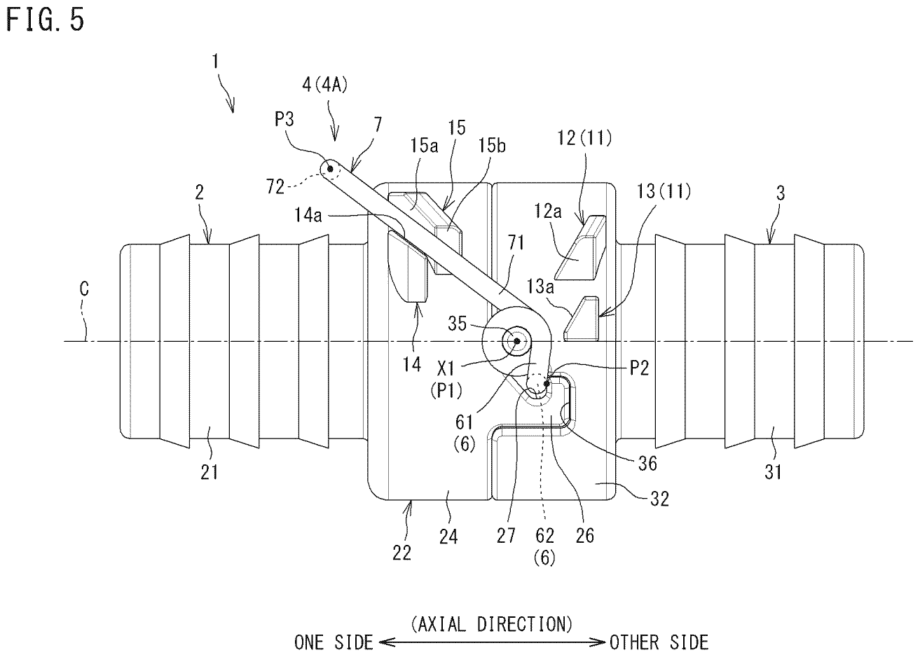

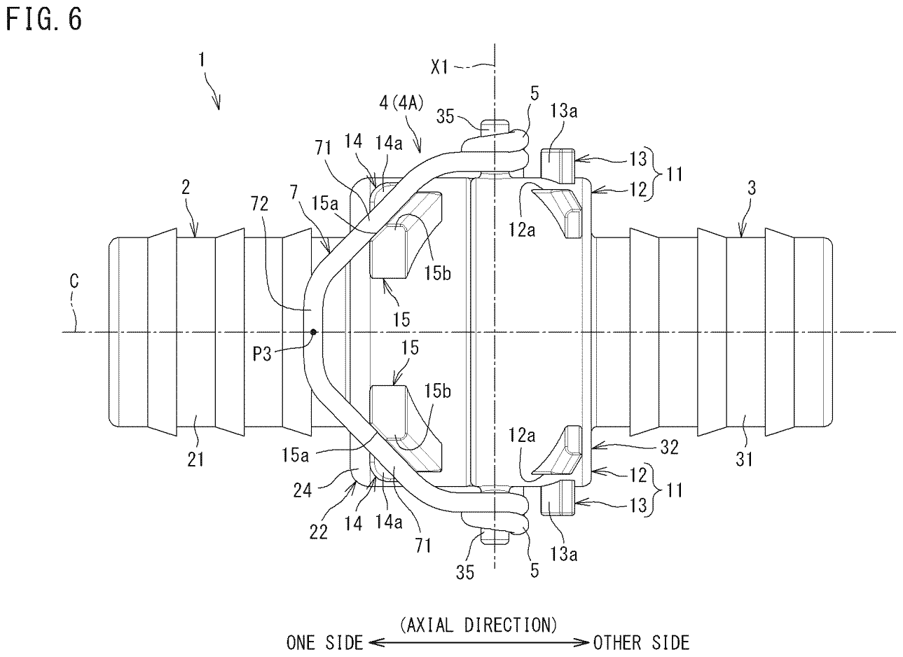

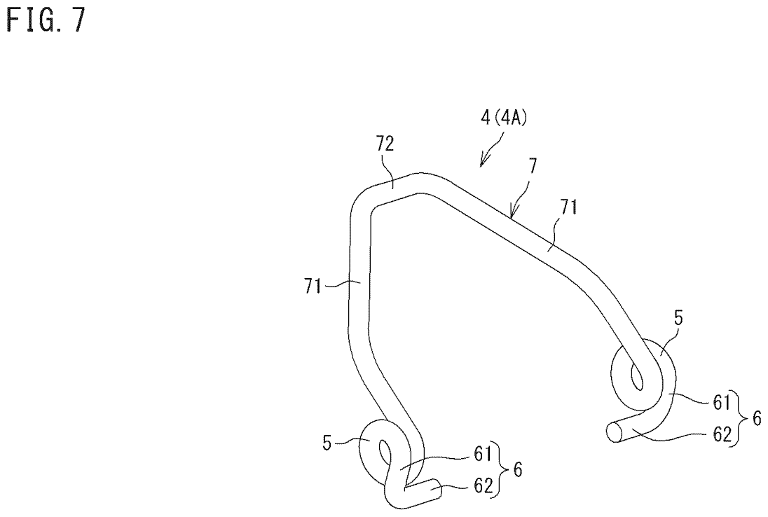

FIG. 5 is a side view of the pipe joint 1 in FIG. 1. FIG. 6 is a plan view of the pipe joint 1 in FIG. 1. FIG. 7 is a perspective view of the assembly mechanism 4. In FIG. 5 to FIG. 7, the assembly mechanism 4 (rod-shaped member 4A) includes a pair of rotation portions 5, a pair of engagement portions 6, and an operation portion 7. The pair of rotation portions 5 are formed in ring shapes with ends by being helically curved by one or more turns, on both sides in the longitudinal direction of the rod-shaped member 4A.

The pair of rotation portions 5 are mounted on the support portions 35 of the second joint 3, respectively. Specifically, each rotation portion 5 is fitted on each support portion 35 and supported so as to be rotatable around a center line X1 extending in the axial direction of each support portion 35 (radial direction of the second joint 3). The rotation center on the center line X1 of each rotation portion 5 functions as a fulcrum P1 of the lever principle described later.

The pair of engagement portions 6 are provided integrally with the rotation portions 5, respectively, at both end portions in the longitudinal direction of the rod-shaped member 4A. Each engagement portion 6 has an extension portion 61 and an acting portion 62. The extension portion 61 extends from one end of the rotation portion 5 in the tangential direction of the rotation portion 5. The acting portion 62 is bent from the distal end of the extension portion 61 and extends inward in the radial direction (direction of the center line X1).

Each engagement portion 6 rotates around the center line X1 together with the corresponding rotation portion 5. At that time, a distal end portion of the acting portion 62 of each engagement portion 6 moves within each cutout groove 36 of the second joint 3. The length of each acting portion 62 in the direction of the center line X1 is dimensioned such that the acting portion 62 does not come into contact with the groove bottom of the cutout groove 36.

When the distal end portion of each acting portion 62 moves within each cutout groove 36, the distal end portion of the acting portion 62 engages with the engagement groove 27 of the protrusion portion 26 inserted into the cutout groove 36. The engagement portion between the acting portion 62 and the engagement groove 27 functions as a point of action P2 of

The operation portion 7 is a portion on which an operator performs an operation for rotating each of the pair of rotation portions 5 around the fulcrum P1 (hereinafter referred to simply as rotational operation) when assembling the pipe joint 1. The operation portion 7 is provided, between the pair of rotation portions 5 of the rod-shaped member 4A, integrally with these rotation portions 5. The operation portion 7 of the present embodiment is formed, for example, in a substantially U shape in a plan view. The operation portion 7 has a pair of arm portions 71 and a grip portion 72.

Each arm portion 71 extends from the other end of each rotation portion 5 in the tangential direction of the rotation portion 5 and in a direction different from that of the extension portion 61 of the engagement portion 6. The distal end sides of the pair of arm portions 71 extend so as to approach each other in a plan view and extend to the outer side in the radial direction of the second joint 3 in a side view.

The grip portion 72 is a portion coupling the distal ends of the pair of arm portions 71 to each other and extends in the direction of the center line X1. The grip portion 72 is a portion gripped by the operator during the rotational operation. A center portion of the grip portion 72 in the center line X1 functions as a point of effort P3 of the lever principle described later. Therefore, the linear distance from the fulcrum P1 to the point of effort P3 is longer than the linear distance from the fulcrum P1 to the point of action P2.

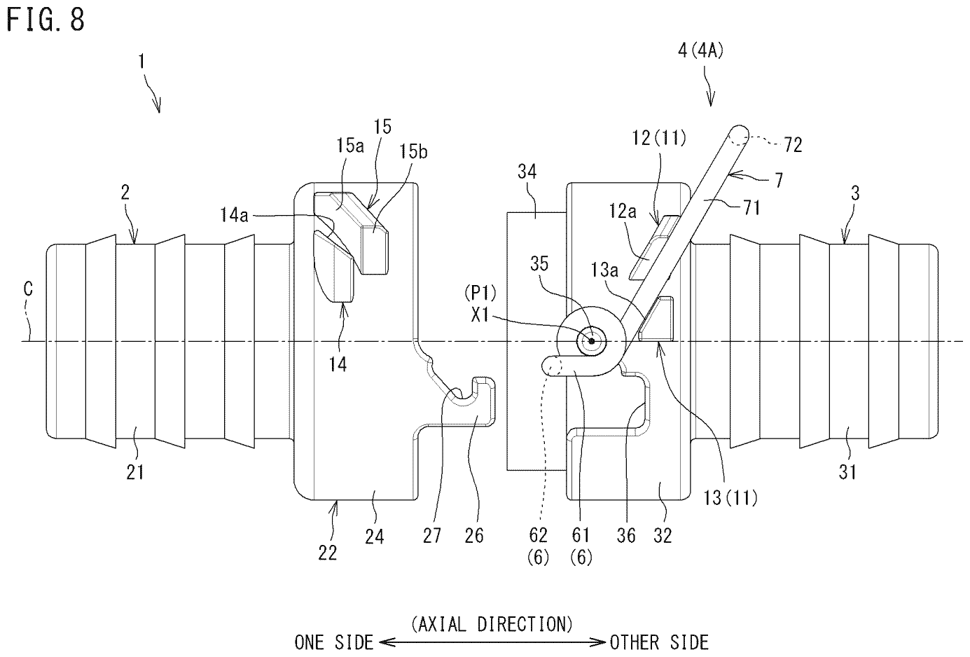

FIG. 8 is a side view showing a state before the pipe joint 1 is assembled. In FIG. 5 and FIG. 8, the operation portion 7 moves while rotating around the fulcrum P1 during the rotational operation. The operation portion 7 is movable from a pre-operation position (FIG. 8) located on the second joint 3 side to a post-operation position (FIG. 5) located on the first joint 2 side, by the rotational operation.

### <Holding Portions>

In FIG. 6 and FIG. 8, the pipe joint 1 further includes a pair of holding portions 11 for holding the operation portion 7 at the pre-operation position. The pair of holding portions 11 are provided on the outer circumferential surface of the second main body portion 32 of the second joint 3 so as to be spaced apart from each other in the circumferential direction.

Each holding portion 11 has a first protrusion 12 and a second protrusion 13. The first protrusion 12 and the second protrusion 13 are provided integrally with the second main body portion 32. The first protrusion 12 restricts the operation portion 7 from moving from the pre-operation position toward the post-operation position side. The first protrusion 12 protrudes outward in the radial direction from the outer circumferential surface of the second main body portion 32.

The first protrusion 12 has a contact surface 12a with which the arm portion 71 contacts at a predetermined pressure when the operation portion 7 is at the pre-operation position (see also FIG. 5). The predetermined pressure of the arm portion 71 against the contact surface 12a is set such that the contact between the arm portion 71 and the contact surface 12a is released when the operator pushes the operation portion 7 toward the post-operation position side. Therefore, the contact surface 12a is positioned so as to permit the arm portion 71 to move from the pre-operation position to the post-operation position.

The second protrusion 13 blocks the operation portion 7 at the pre-operation position from moving toward a side opposite to the post-operation position side. The second protrusion 13 protrudes outward in the radial direction from a position close to the first protrusion 12 on the outer circumferential surface of the second main body portion 32. The second protrusion 13 has a contact surface 13a with which the arm portion 71 contacts when the operation portion 7 is at the pre-operation position. The contact surface 13a is positioned so as to block the arm portion 71 from moving from the pre-operation position toward the opposite side. Accordingly, the second protrusion 13 blocks the operation portion 7 from moving from the pre-operation position toward the opposite side.

### <Blocking Portions>

In FIG. 5 and FIG. 6, the pipe joint 1 further includes a pair of blocking portions 14 for blocking the operation portion 7 from moving beyond the post-operation position during the rotational operation. The pair of blocking portions 14 are provided on the outer circumferential surface of the first main body portion 22 of the first joint 2 so as to be spaced apart from each other in the circumferential direction and protrude outward in the radial direction. Each blocking portion 14 of the present embodiment is provided integrally with the first main body portion 22.

Each blocking portion 14 has a contact surface 14a with which the arm portion 71 contacts when the operation portion 7 is at the post-operation position (see also FIG. 3). Each contact surface 14a is positioned so as to block each arm portion 71 from moving beyond the post-operation position. Accordingly, each blocking portion 14 blocks the operation portion 7 from moving beyond the post-operation position.

### <Restricting Portions>

The pipe joint 1 further includes a pair of restricting portions 15 for restricting the operation portion 7 from moving from the post-operation position toward the pre-operation position side. The pair of restricting portions 15 are provided on the outer circumferential surface of the first main body portion 22 of the first joint 2 so as to be spaced apart from each other in the circumferential direction. The pair of restricting portions 15 protrude outward in the radial direction from positions close to the blocking portions 14, respectively. Each restricting portion 15 of the present embodiment is provided integrally with the first main body portion 22.

Each restricting portion 15 has a contact surface 15a and an overpassing portion 15b. The overpassing portion 15b is formed on the outer side of the restricting portion 15 in the direction of the center line X1 in a plan view. The overpassing portion 15b is a portion with which the arm portion 71 of the operation portion 7 contacts at a position before the post-operation position, in the middle of the rotational operation. The arm portion 71 that is in contact with the overpassing portion 15b passes over the overpassing portion 15b, while bending and deforming outward in the direction of the center line X1, by the operator pushing the operation portion 7 toward the post-operation position side in this state.

The contact surface 15a is a surface with which the arm portion 71 having passed over the overpassing portion 15b and moved to the post-operation position comes into contact. The contact surface 15a is positioned so as to restrict movement from the post-operation position toward the pre-operation position side. Accordingly, each restricting portion 15 restricts the operation portion 7 from moving from the post-operation position toward the pre-operation position side.

### <Description of Middle of Assembling Pipe Joint>

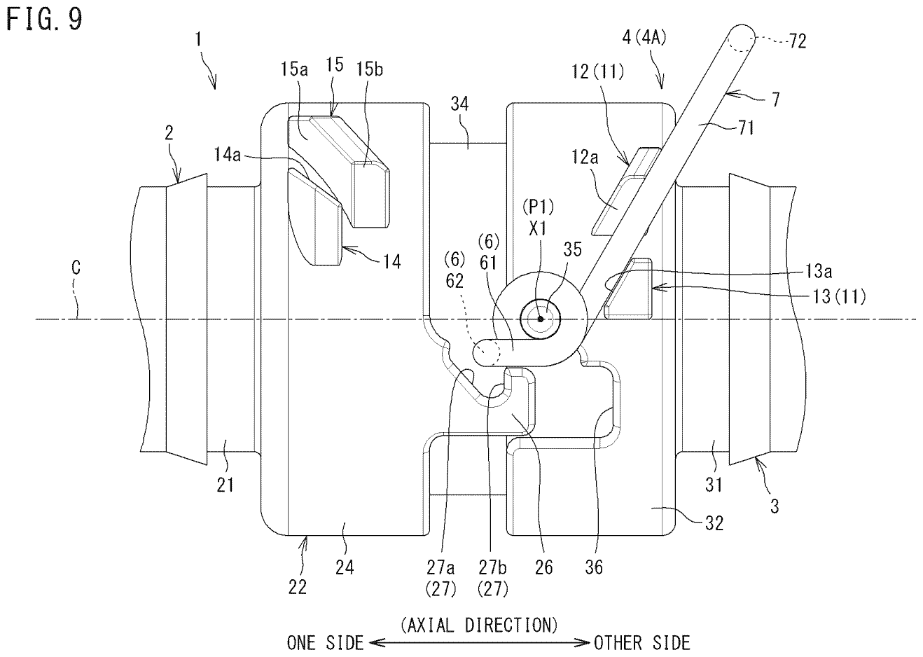

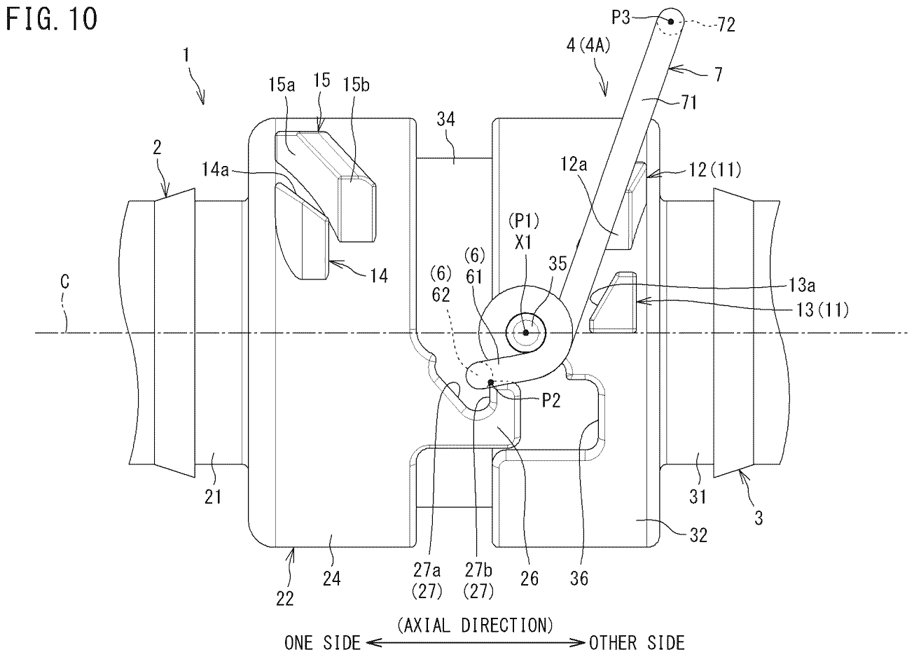

FIG. 9 and FIG. 10 are each a side view showing a state in the middle of assembling the pipe joint 1. FIG. 9 shows a state where the first joint 2 has been brought closer to the second joint 3 from the state shown in FIG. 8. In this state, the distal end portion of each protrusion portion 26 of the first joint 2 is inserted into the corresponding cutout groove 36 of the second joint 3. FIG. 10 shows an initial state where the engagement portion 6 has been engaged with the engagement groove 27 of the first joint 2 by the rotational operation on the operation portion 7 from the state shown in FIG. 9. In FIG. 9 and FIG. 10, the engagement groove 27 has an inclined surface 27a formed on the one side in the axial direction and an engagement surface 27b formed on the other side in the axial direction.

The inclined surface 27a is inclined such that the groove depth of the engagement groove 27 gradually increases from the one side in the axial direction toward the other side in the axial direction. Accordingly, when the engagement portion 6 rotates about the fulcrum Pl in a counterclockwise direction in the drawing by the rotational operation on the operation portion 7 from the state shown in FIG. 9, the acting portion 62 of the engagement portion 6 can be inhibited from interfering with the inclined surface 27a of the engagement groove 27.

The engagement surface 27b is a surface with which the outer circumferential surface of the acting portion 62 of the engagement portion 6 engages. The engagement surface 27b extends straight in the up-down direction in FIG. 9 in a side view. When the operator performs a rotational operation for moving the grip portion 72 of the operation portion 7 toward the post-operation position side (left side in the drawing) from the state shown in FIG. 9, the acting portion 62 of the engagement portion 6 moves within the engagement groove 27, and the outer circumferential surface of the acting portion 62 engages with the engagement surface 27b as shown in FIG. 10. The engagement portion between the acting portion 62 and the engagement surface 27b functions as the point of action P2.

When, from the state shown in FIG. 10, the operator further pushes the grip portion 72 of the operation portion 7 toward the post-operation position side and rotates the engagement portion 6 around the fulcrum P1 together with the rotation portion 5, a force toward the other side in the axial direction is applied from the point of effort P3 of the grip portion 72 to the point of action P2, which is the engagement portion between the engagement portion 6 and the engagement groove 27, due to the lever principle. By the force applied to the point of action P2, the sealing protrusion 23 (see FIG. 2) of the first joint 2 is gradually press-fitted into the sealing groove 33 of the second joint 3.

As shown in FIG. 5, when the operator pushes the grip portion 72 of the operation portion 7 to the post-operation position, the sealing protrusion 23 becomes press-fitted to an appropriate position within the sealing groove 33. Accordingly, a sealing surface pressure is generated between the inner circumferential surfaces of the sealing protrusion 23 and the sealing groove 33, and the connection portion between the first joint 2 and the second joint 3 is sealed.

### <Angular Range in Which Point of Action Moves>

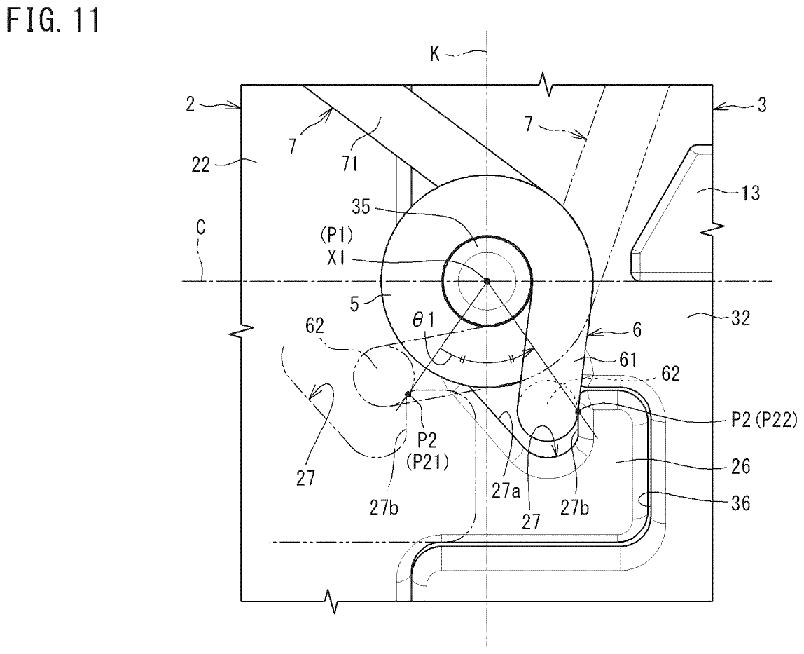

FIG. 11 is an enlarged side view showing an angular range in which the point of action P2 moves during the rotational operation on the operation portion 7. The point of action P2 at a position shown by an alternate long and two short dashes line in FIG. 11 (hereinafter also referred to as point of action P21) indicates the state shown in FIG. 10, that is, the initial state where the acting portion 62 (engagement portion 6) has been engaged with the engagement surface 27b (engagement groove 27) by the rotational operation. The point of action P2 at a position shown by a solid line in FIG. 11 (hereinafter also referred to as point of action P22) indicates the state shown in FIG. 5, that is, an engagement state between the acting portion 62 and the engagement surface 27b when the sealing protrusion 23 has been press-fitted to the appropriate position within the sealing groove 33 by the rotational operation (see FIG. 2).

In FIG. 11, the point of action P2 rotationally moves within a predetermined angular range θ1 centered on the fulcrum P1 during the rotational operation. The angular range θ1 is set to a range bisected by a virtual line K that is perpendicular to the axis C of the second joint 3 and the center line X1 of the support portion 35 and passes through the fulcrum P1. The reason for this will be described below.

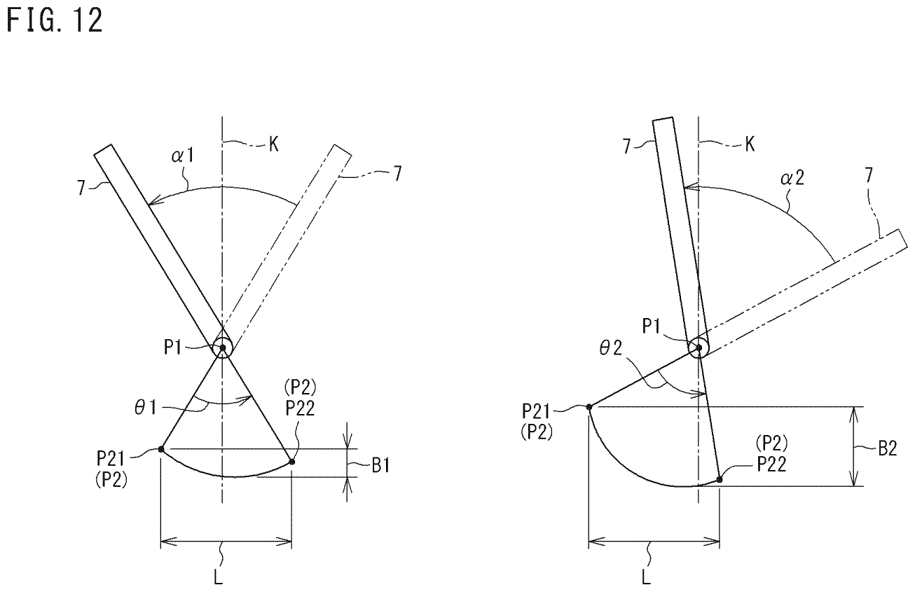

FIG. 12 is a schematic diagram showing two angular ranges different from each other. The left drawing in FIG. 12 shows the angular range θ1 of the present embodiment.

The right drawing in FIG. 12 shows an angular range θ2 that is set to a range not bisected by the virtual line K. As shown in FIG. 12, even if the setting ranges of the respective angular ranges θ1 and θ2 are different, the distance in the axial direction from the point of action P21 to the point of action P22, that is, a press-fitting distance L for press-fitting the sealing protrusion 23 to the appropriate position within the sealing groove 33, needs to be the same.

In FIG. 12, when the press-fitting distances L in the left and right drawings are set to the same distance, a distance B2 in a direction along the virtual line K (up-down direction in the drawing) from the point of action P21 to the point of action P22 in the right drawing is longer than a distance B1 in the direction along the virtual line K from the point of action P21 to the point of action P22 in the left drawing. Therefore, the amount of movement (axis shift), in the direction along the virtual line K, of the point of action P2 in the left drawing during the rotational operation is larger than that of the point of action P2 in the right drawing. As the amount of movement increases, the force in the axial direction along the axis C, that is, in the press-fitting direction in which the sealing protrusion 23 is press-fitted into the sealing groove 33, is dispersed and weakened. Therefore, in the present embodiment, to reduce the amount of movement of the point of action P2 as much as possible, the angular range θ1 of the point of action P2 is set to the range bisected by the virtual line K.

Furthermore, when the press-fitting distances L in the left and right drawings are set to the same distance, the angular range θ2 in the left drawing becomes larger than the angular range θ1 in the right drawing. Therefore, an operating angle α1 of the operation portion 7 during the rotational operation in the left drawing becomes larger than an operating angle α2 of the operation portion 7 during the rotational operation in the right drawing. Therefore, in the present embodiment, the angular range θ1 of the point of action P2 is set to the range bisected by the virtual line K also from the viewpoint of reducing the operating angle α1 of the operation portion 7 as much as possible.

### Advantageous Effects

In the pipe joint 1 of the present embodiment, the operator can perform a rotational operation for rotating each rotation portion 5 around the fulcrum P1 relative to the second joint 3 by using the operation portion 7. At this time, by the engagement portion 6 engaging with the first joint 2, a force in the direction in which the sealing protrusion 23 of the first joint 2 is inserted into the sealing groove 33 of the second joint 3 is applied from the point of effort P3 of the operation portion 7 to the point of action P2 which is the engagement portion between the engagement portion 6 and the first joint 2. Accordingly, the operator can easily insert the sealing protrusion 23 of the first joint 2 into the sealing groove 33 of the second joint 3 by using the assembly mechanism 4 which utilizes the lever principle. Therefore, even if the sealing surface pressure between the sealing protrusion 23 and the sealing groove 33 is increased to improve sealing performance, the work of assembling the pipe joint 1 can be easily performed.

In the assembly mechanism 4, the engagement portions 6 and the operation portion 7 are provided integrally with the rotation portions 5, and thus the configuration of the pipe joint 1 can be simplified. In addition, the assembly mechanism 4 is made of a resin material and thus can be produced at a lower cost compared to a metal material.

Before the operator performs the rotational operation on the operation portion 7, the operation portion 7 is held at the pre-operation position on the second joint 3 side by the holding portion 11 (see FIG. 8). In this state, when the operator brings the first joint 2 closer to the second joint 3 (see FIG. 9), the first joint 2 can be inhibited from interfering with the operation portion 7. Accordingly, the work of assembling the pipe joint 1 can be performed more easily.

When the operator performs the rotational operation on the operation portion 7, the operation portion 7 can be blocked from moving beyond the post-operation position, by the blocking portions 14 (see FIG. 5). Accordingly, damage to the operation portion 7, the engagement portions 6, etc., due to an erroneous operation on the operation portion 7 can be suppressed.

After the operator performs the rotational operation on the operation portion 7, the operation portion 7 can be restricted from moving from the post-operation position toward the pre-operation position side, by the restricting portions 15 (see FIG. 5). Accordingly, since each engagement portion 6 is held in a state of being engaged with the first joint 2, movement of the sealing protrusion 23 of the first joint 2 in a direction of coming out from the sealing groove 33 of the second joint 3, due to vibration or the like, can be suppressed. As a result, a decrease in sealing performance due to a decrease in the sealing surface pressure between the sealing protrusion 23 and the sealing groove 33 can be suppressed.

The angular range θ1 in which the point of action P2 rotationally moves around the fulcrum P1 by the rotational operation is set to the range bisected by the virtual line K which is perpendicular to the axis C of the second joint 3 and the center line X1 in the radial direction and passes through the fulcrum P1 (see FIG. 12). Accordingly, the amount of movement (distance B1) of the point of action P2 in the direction along the virtual line K can be reduced as much as possible, and thus, weakening of the force in the direction in which the sealing protrusion 23 is press-fitted into the sealing groove 33 can be suppressed. In addition, since the angular range θ1 can be reduced as much as possible, the operating angle αl during the rotational operation on the operation portion 7 can also be reduced. Accordingly, the work of assembling the pipe joint 1 can be performed efficiently.

In general, the second joint 3 having the sealing groove 33 is longer in the axial direction than the first joint 2 having the sealing protrusion 23. Since the rotation portions 5 of the present embodiment are provided in the second joint 3 which is relatively long in the axial direction, increasing the length of the second joint 3 in the axial direction in order to ensure the spaces for providing the rotation portions 5 can be suppressed as much as possible. Accordingly, an increase in the overall length of the pipe joint 1 in the axial direction after assembly can be suppressed.

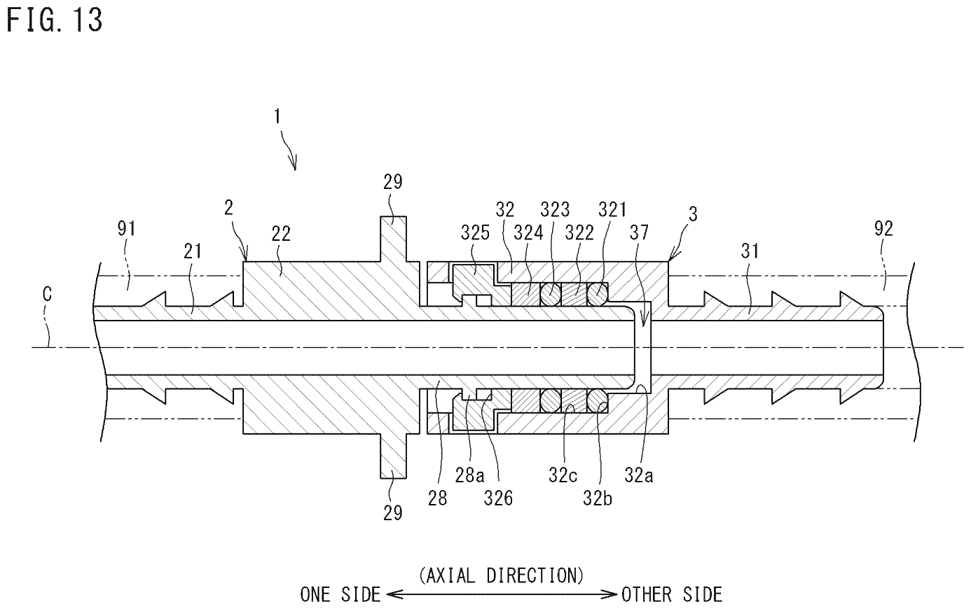

FIG. 13 is an axial cross-sectional view of a pipe joint 1 according to a second embodiment. The pipe joint 1 of the second embodiment differs from that of the first embodiment in that the respective configurations of the first joint 2 and the second joint 3 are different. In FIG. 13, the assembly mechanism 4 is not shown.

In FIG. 13, the first joint 2 includes a first connection portion 21, a first main body portion 22, and an insertion portion 28. The insertion portion 28 is formed in a cylindrical shape and extends from the first main body portion 22 toward the other side in the axial direction. The outer diameter of the insertion portion 28 is smaller than the outer diameter of the first main body portion 22 and is substantially the same as the outer diameter of the first connection portion 21. The insertion portion 28 has an annular locking portion 28a that protrudes outward in the radial direction.

As in the first embodiment, the second joint 3 includes a second connection portion 31 and a second main body portion 32. On the inner circumference of the second main body portion 32, a small-diameter surface 32a, a step surface 32b, and a large-diameter surface 32c are formed in this order from the other side in the axial direction. The inner diameter of the small-diameter surface 32a is slightly larger than the outer diameter of the insertion portion 28 of the first joint 2. The step surface 32b is an annular surface extending outward in the radial direction from one end in the axial direction of the small-diameter surface 32a. The large-diameter surface 32c extends from the radially outer end of the step surface 32b toward the one side in the axial direction. The inner diameter of the large-diameter surface 32c is larger than the inner diameter of the small-diameter surface 32a.

The second joint 3 further includes an O-ring 321, an annular spacer 322, an O-ring 323, a retainer ring 324, and an annular retainer 325. The O-ring 321, the spacer 322, the O-ring 323, and the retainer ring 324 are inserted into the second main body portion 32 in this order from the one side in the axial direction and are fitted to the large-diameter surface 32c.

The retainer 325 is fixed to the second main body portion 32 at a position adjacent to the one side in the axial direction of the retainer ring 324. The retainer 325 holds the O-ring 321, the spacer 322, the O-ring 323, and the retainer ring 324 between the step surface 32b of the second main body portion 32 and the retainer 325. A locking groove 326 into which the locking portion 28a of the insertion portion 28 of the first joint 2 is locked is formed on the inner circumference of the retainer 325. The inner diameter of each O-ring 321 or 323 is slightly smaller than the outer diameter of the insertion portion 28 of the first joint 2. The inner diameters of the spacer 322, the retainer ring 324, and the retainer 325 are slightly larger than the outer diameter of the insertion portion 28.

The second main body portion 32 has an insertion target portion 37 into which the insertion portion 28 of the first joint 2 is inserted from the one side in the axial direction. The insertion target portion 37 is the internal space of the second main body portion 32 formed by the respective inner circumferential surfaces of the O-ring 321, the spacer 322, the O-ring 323, the retainer ring 324, and the retainer 325 and the small-diameter surface 32a. When the insertion portion 28 is inserted into the insertion target portion 37, the locking portion 28a is locked into the locking groove 326, and the inner circumferential side of each O-ring 321 or 323 is brought into close contact with the outer circumferential surface of the insertion portion 28. A sealing surface pressure is generated at the close contact portion of the outer circumferential surface of the insertion portion 28 with each O-ring 321 or 323. Accordingly, the connection portion between the first joint 2 and the second joint 3 is sealed.

The first main body portion 22 of the first joint 2 has a pair of support portions 29 provided on the outer circumferential surface thereof. The pair of rotation portions 5 (not shown) of the assembly mechanism 4 are rotatably supported by the support portions 29, respectively. The other components of the present embodiment are the same as those of the first embodiment, and thus are designated by the same reference signs, and the description thereof is omitted.

Due to the above, in the pipe joint 1 of the second embodiment as well, the operator can easily insert the insertion portion 28 of the first joint 2 into the insertion target portion 37 of the second joint 3 by using the assembly mechanism 4 which utilizes the lever principle. Therefore, even if the sealing surface pressure generated at the insertion portion 28 is increased to improve sealing performance, the work of assembling the pipe joint 1 can be easily performed.

### Third Embodiment

### <Configuration of Pipe Joint>

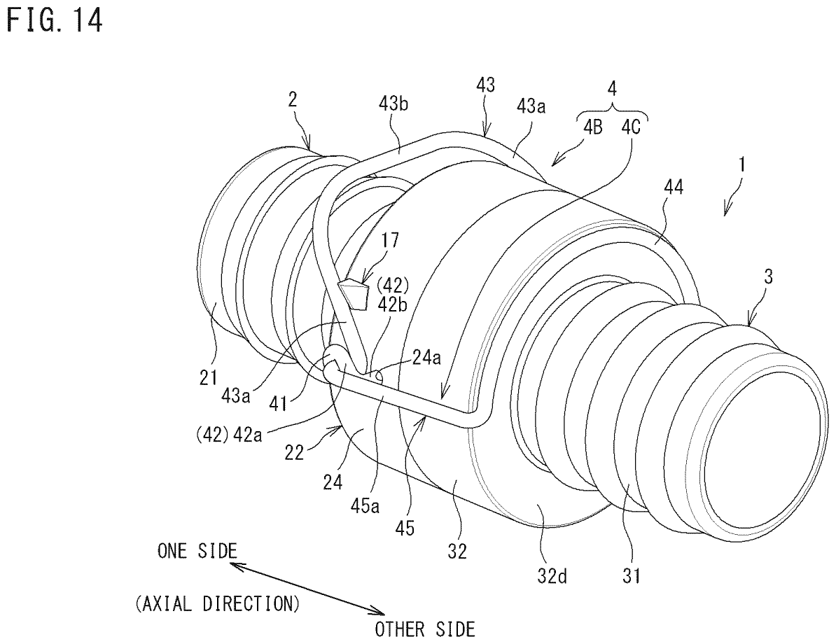

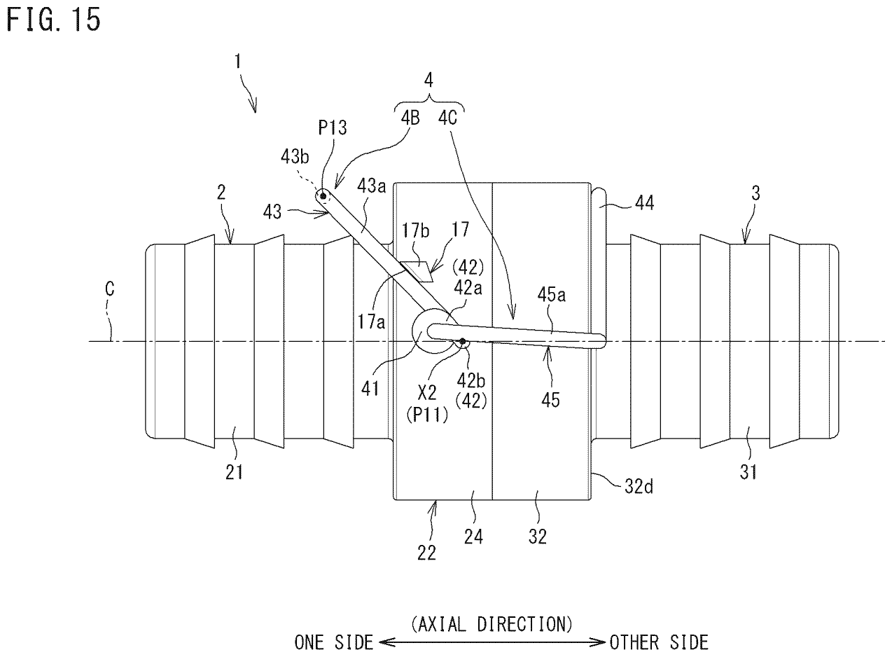

FIG. 14 is a perspective view of a pipe joint 1 according to a third embodiment. FIG. 15 is a side view of the pipe joint 1. The pipe joint 1 of the third embodiment differs from that of the first embodiment in that the configuration of the assembly mechanism 4 is different. The assembly mechanism 4 of the present embodiment is composed of a first rod-shaped member 4B and a second rod-shaped member 4C.

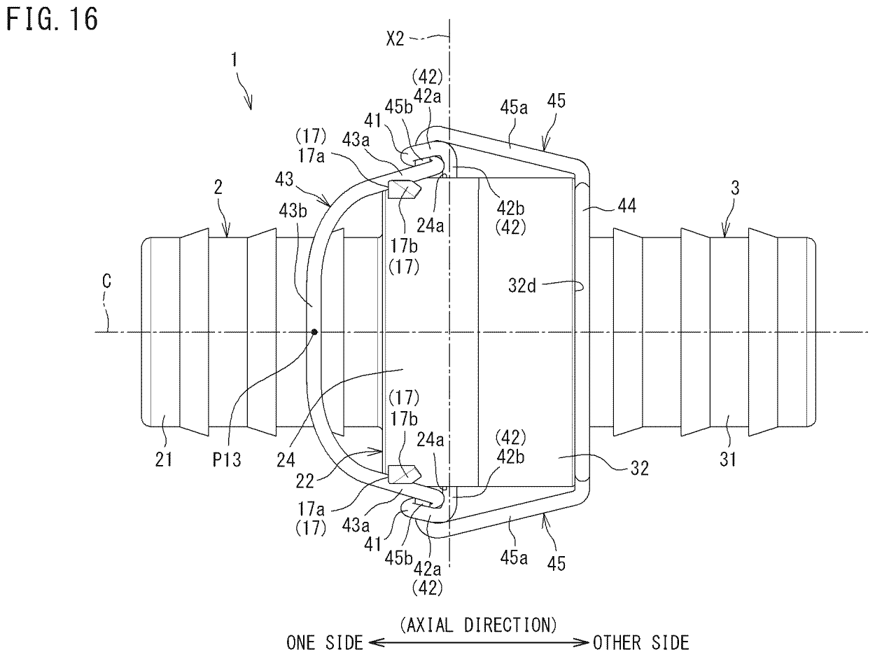

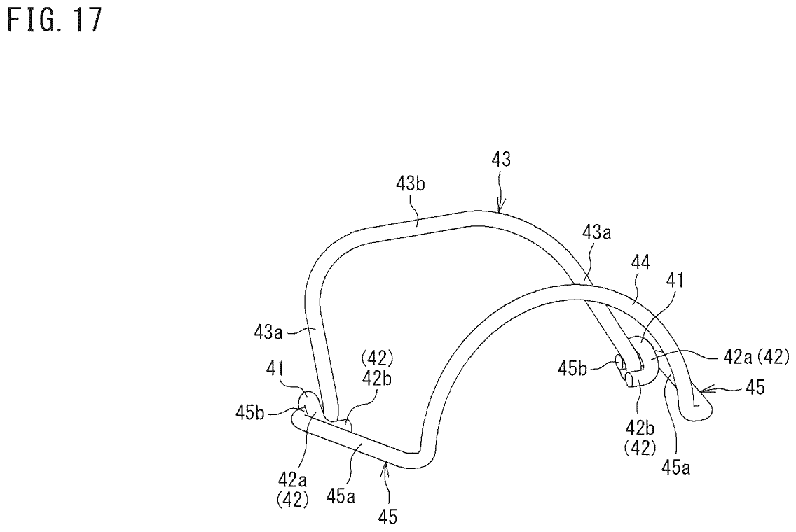

FIG. 16 is a plan view of the pipe joint 1 of the third embodiment. FIG. 17 is a perspective view of the assembly mechanism 4 in the pipe joint 1. In FIG. 15 to FIG. 17, the first rod-shaped member 4B of the assembly mechanism 4 includes a pair of acting portions 41, a pair of rotation portions 42, and an operation portion 43.

The pair of acting portions 41 are formed in ring shapes with ends by being helically curved by one or more turns, on both sides in the longitudinal direction of the first rod-shaped member 4B. The pair of rotation portions 42 are provided integrally with the acting portions 41, respectively, at both end portions in the longitudinal direction of the first rod-shaped member 4B. Each rotation portion 42 has a swing portion 42a and a rotation shaft 42b.

The swing portion 42a extends from one end of the acting portion 41 in the tangential direction of the acting portion 41. The rotation shaft 42b is bent from the distal end of the swing portion 42a and extends inward in the radial direction (the direction of a center line X2 described later). A distal end portion of the rotation shaft 42b is inserted into a mounting hole 24a (see FIG. 14) formed on the outer circumference of the first main body portion 22 of the first joint 2 and is supported so as to be rotatable around the center line X2 of the mounting hole 24a. The rotation center on the center line X2 of each rotation portion 42 (rotation shaft 42b) functions as a fulcrum P11 of a lever principle described later.

The operation portion 43 is a portion on which the operator performs an operation for rotating each of the pair of rotation portions 42 around the fulcrum P11 (hereinafter referred to simply as rotational operation) when assembling the pipe joint 1. The operation portion 43 is provided, between the pair of acting portions 41 of the first rod-shaped member 4B, integrally with these acting portions 41. The operation portion 43 of the present embodiment is formed in a substantially U shape in a plan view, similar to the operation portion 7 of the first embodiment. The operation portion 43 has a pair of arm portions 43a and a grip portion 43b.

Each arm portion 43a extends from the other end of each acting portion 41 in the tangential direction of the acting portion 41 and in a direction different from the swing portion 42a of the rotation portion 42. The distal end sides of the pair of arm portions 43a extend so as to approach each other in a plan view and extend to the outer side in the radial direction of the second joint 3 in a side view.

The grip portion 43b is a portion coupling the distal ends of the pair of arm portions 43a to each other and extends in the direction of the center line X2. The grip portion 43b is a portion gripped by the operator during the rotational operation. A center portion of the grip portion 43b in the center line X2 functions as a point of effort P13 of the lever principle described later. Therefore, the linear distance from the fulcrum P11 to the point of effort P13 is longer than the linear distance from the fulcrum P11 to a point of action P12 (described later).

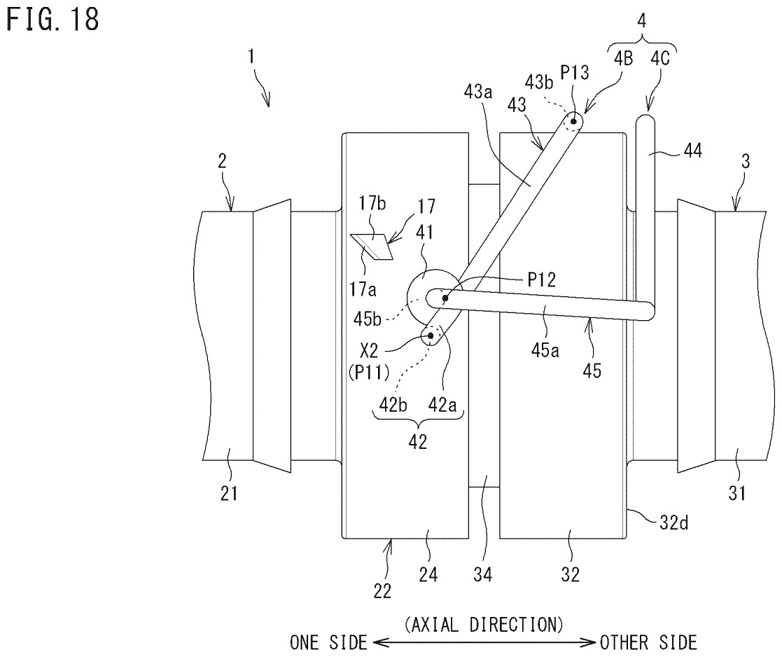

FIG. 18 is a side view showing a state before the pipe joint 1 of the present embodiment is assembled. In FIG. 15 and FIG. 18, the operation portion 43 moves while rotating around the fulcrum P11 during the rotational operation. The operation portion 43 is movable from a pre-operation position (FIG. 18) located on the other side in the axial direction with respect to the fulcrum P11 to a post-operation position (FIG. 15) located on the one side in the axial direction with respect to the fulcrum P11, by the rotational operation.

In FIG. 15 and FIG. 16, the pipe joint 1 further includes a pair of restricting portions 17 for restricting the operation portion 43 from moving from the post-operation position toward the pre-operation position side. The pair of restricting portions 17 are provided on the outer circumferential surface of the first main body portion 22 of the first joint 2 so as to be spaced apart from each other in the circumferential direction. The pair of restricting portions 17 protrude outward in the radial direction from the outer circumferential surface of the first main body portion 22. Each restricting portion 17 of the present embodiment is provided integrally with the first main body portion 22.

Each restricting portion 17 has a contact surface 17a and an overpassing portion 17b. The overpassing portion 17b is a portion with which the arm portion 43a of the operation portion 43 contacts at a position before the post-operation position, in the middle of the rotational operation. The arm portion 43a that is in contact with the overpassing portion 17b passes over the overpassing portion 17b, while bending and deforming outward in the direction of the center line X2, by the operator pushing the operation portion 7 toward the post-operation position side in this state.

The contact surface 17a is a surface with which the arm portion 43a having passed over the overpassing portion 17b and moved to the post-operation position comes into contact. The contact surface 17a is positioned so as to restrict movement from the post-operation position toward the pre-operation position side. Accordingly, each restricting portion 17 restricts the operation portion 43 from moving from the post-operation position toward the pre-operation position side.

In FIG. 15 to FIG. 17, the second rod-shaped member 4C of the assembly mechanism 4 includes an engagement portion 44 and a pair of coupling portions 45. The engagement portion 44 is formed in a semicircular arc shape at an intermediate portion in the longitudinal direction of the second rod-shaped member 4C. The engagement portion 44 is placed along the outer circumferential surface of the second connection portion 31 of the second joint 3 and is also placed so as to face an end surface 32d on the other side in the axial direction of the second main body portion 32.

The pair of coupling portions 45 are provided integrally with the engagement portion 44 on both sides in the longitudinal direction of the second rod-shaped member 4C. Each coupling portion 45 has an extension portion 45a and a coupling shaft 45b.

The extension portion 45a extends from an end portion of the engagement portion 44 toward the one side in the axial direction. The extension portion 45a passes through the outer side in the radial direction of the second main body portion 32 and extends to the outer side in the radial direction of the first main body portion 22 of the first joint 2. An end portion on the one side in the axial direction of the extension portion 45a is located radially outward of the acting portion 41 of the first rod-shaped member 4B.

The coupling shaft 45b extends inward in the radial direction from the end portion on the one side in the axial direction of the extension portion 45a. The coupling shaft 45b of each coupling portion 45 is inserted into the inner circumferential side of the acting portion 41 of the first rod-shaped member 4B and coupled to the acting portion 41. The acting portion 41 moves (swings) in the axial direction when the rotation shaft 42b rotates around the center line X2. When the acting portion 41 moves toward the one side in the axial direction from the state shown in FIG. 18, the contact portion between the acting portion 41 and the coupling shaft 45b functions as the point of action P12 of the lever principle described later.

### <Description of Middle of Assembling Pipe Joint>

As shown in FIG. 18, when the first joint 2 is brought closer to the second joint 3 side in a state where the operation portion 43 is at the pre-operation position, the engagement portion 44 is positioned on the other side in the axial direction with respect to the end surface 32d of the second joint 3 (second main body portion 32). When the operator performs a rotational operation for moving the grip portion 43b of the operation portion 43 toward the post-operation position side (left side in the drawing) from the state shown in FIG. 18, the rotation portion 42 rotates around the fulcrum P11 in a counterclockwise direction in the drawing.

When the rotation portion 42 rotates as described above, a force toward the one side in the axial direction is applied from the point of effort P13 of the grip portion 43b of the operation portion 43 to the point of action P12 which is the contact portion between the acting portion 41 and the coupling shaft 45b, due to the lever principle. By the force applied to the point of action P12, the acting portion 41 and the coupling shaft 45b move toward the one side in the axial direction relative to the fulcrum P11, and the extension portion 45a and the engagement portion 44 also follow this movement to move toward the one side in the axial direction. Accordingly, the engagement portion 44 engages with the end surface 32d of the second joint 3. From this state, when the operator further performs the rotational operation, the second joint 3 is pressed toward the one side in the axial direction by the engagement portion 44, whereby the sealing protrusion 23 (see FIG. 2) of the first joint 2 is gradually press-fitted into the sealing groove 33 of the second joint 3.

As shown in FIG. 15, when the operator further pushes the grip portion 43b of the operation portion 43 to the post-operation position, the sealing protrusion 23 becomes press-fitted to an appropriate position within the sealing groove 33. Accordingly, a sealing surface pressure is generated between the inner circumferential surfaces of the sealing protrusion 23 and the sealing groove 33, and the connection portion between the first joint 2 and the second joint 3 is sealed.

The other components of the present embodiment are the same as those of the first embodiment, and thus are designated by the same reference signs, and the description thereof is omitted.

In the pipe joint 1 of the third embodiment as well, the operator can easily insert the sealing protrusion 23 of the first joint 2 into the sealing groove 33 of the second joint 3 by using the assembly mechanism 4 which utilizes the lever principle. Therefore, even if the sealing surface pressure between the sealing protrusion 23 and the sealing groove 33 is increased to improve sealing performance, the work of assembling the pipe joint 1 can be easily performed.

### Others

The embodiments disclosed herein are merely illustrative and not restrictive in all aspects. For example, the pipe joint 1 of each embodiment described above is not limited to use in an electric vehicle. The assembly mechanism 4 of each embodiment described above may be a member (e.g., a wire) made of a material other than a resin material, such as a metal material.

The engagement portions 6 and the operation portion 7 of the assembly mechanism 4 of the first embodiment are provided integrally with the rotation portions 5 but may be provided separately from the rotation portions 5. The rotation portions 5 of the first embodiment are provided in the second joint 3 but may be provided in the first joint 2. In this case, the support portions 35 which support the rotation portions 5 are provided in the first joint 2.

The rotation portions 5 (not shown) of the second embodiment are provided in the first joint 2 but may be provided in the second joint 3. In this case, the support portions 35 which support the rotation portions 5 are provided in the second joint 3. Similarly, the rotation portions 42 of the third embodiment are provided in the first joint 2 but may be provided in the second joint 3. In this case, the restricting portions 17 are also provided in the second joint 3. In addition, the engagement portion 44 may be engaged with the end surface of the first main body portion 22 of the first joint 2.

The holding portion 11 of the first embodiment is provided at two locations in the circumferential direction in the second joint 3 but may be provided at only one location in the circumferential direction. Similarly, the blocking portion 14 and the restricting portion 15 of the first embodiment are each provided at two locations in the circumferential direction in the first joint 2 but may each be provided at only one location in the circumferential direction. Similarly, the restricting portion 17 of the third embodiment is provided at two locations in the circumferential direction in the first joint 2 but may be provided at only one location in the circumferential direction.

### REFERENCE SIGNS LIST

1 pipe joint
2 first joint
3 second joint
4 assembly mechanism
5 rotation portion
6 engagement portion
7 operation portion
11 holding portion
14 blocking portion
15 restricting portion
23 sealing protrusion (insertion portion)
28 insertion portion
33 sealing groove (insertion target portion)
37 insertion target portion
91 first hose (one pipe)
92 first hose (other pipe)
C axis
P1 fulcrum
P2 point of action
P3 point of effort
K virtual line
X1 center line
θ angular range

1. A pipe joint comprising:
a tubular first joint configured to be connected to one pipe and having an insertion portion extending in an axial direction; and
a tubular second joint configured to be connected to another pipe and having an insertion target portion into which the insertion portion is inserted in the axial direction,
a sealing surface pressure being generated at the insertion portion when the insertion portion is inserted into the insertion target portion, wherein
the pipe joint comprises an assembly mechanism for inserting the insertion portion into the insertion target portion by utilizing a lever principle.

2. The pipe joint according to claim 1, wherein
the assembly mechanism includes
a rotation portion that is provided at an outer circumference of one joint out of the first joint and the second joint so as to be rotatable around a center line extending in a radial direction of the one joint,
an engagement portion that is provided at the rotation portion and engageable with the other joint out of the first joint and the second joint by rotation of the rotation portion, and
an operation portion that is provided at the rotation portion and on which a rotational operation for rotating the rotation portion about the center line as a fulcrum is performed, and
the operation portion has a point of effort at which a force in a direction in which the insertion portion is inserted into the insertion target portion is applied to a point of action, which is an engagement portion between the engagement portion and the other joint, by the rotational operation.

3. The pipe joint according to claim 2, wherein the engagement portion and the operation portion are provided integrally with the rotation portion.

4. The pipe joint according to claim 2, wherein
the operation portion is movable from a pre-operation position located on the one joint side to a post-operation position located on the other joint side, by the rotational operation, and
the pipe joint further comprises a holding portion provided in the one joint and configured to hold the operation portion at the pre-operation position.

5. The pipe joint according to claim 2, wherein
the operation portion is movable from a pre-operation position located on the one joint side to a post-operation position located on the other joint side, by the rotational operation, and
the pipe joint further comprises a blocking portion provided in the other joint and configured to block the operation portion from moving beyond the post-operation position during the rotational operation.

6. The pipe joint according to claim 2, wherein
the operation portion is movable from a pre-operation position located on the one joint side to a post-operation position located on the other joint side, by the rotational operation, and
the pipe joint further comprises a restricting portion provided in the other joint and configured to restrict the operation portion from moving from the post-operation position toward the pre-operation position side.

7. The pipe joint according to claim 2, wherein
the point of action is rotationally movable in a predetermined angular range centered on the fulcrum, by the rotational operation, and
the angular range is set to a range bisected by a virtual line that is perpendicular to an axis of the one joint and the center line and passes through the fulcrum.

8. The pipe joint according to claim 2, wherein the rotation portion is provided in the second joint.
